(19) United States
(12) Patent Application Publication
(10) Pub. No.: US 2007/0184893 A1
(43) Pub. Date: Aug. 9, 2007

(54) Gaming machine

(75) Inventor: Jun Fujimoto, Tokyo (JP)

Correspondence Address: ARENT FOX PLLC, 1050 CONNECTICUT AVENUE, N.W., SUITE 400, WASHINGTON, DC, 20036, US

(73) Assignee: Aruze Corporation

(21) Appl. No.: 11/702,198

(22) Filed: Feb. 5, 2007

(30) Foreign Application Priority Data
Feb. 9, 2006 (JP) 2006-032533

(51) Int. Cl. A63F 13/00

(52) U.S. Cl. 463/20

(57) ABSTRACT

A gaming machine in which an effect to enable the hidden symbol to become visible is performed based on the player's operation is provided. In such a gaming machine, unpredictable game contents may be provided without giving the player stress or irritation, or preventing the player from feeling monotony. This gaming machine is characterized by comprising: an effect rotational reel configured with a array of symbols; a multiplication display part provided between the rotational reel and a player; a lower liquid crystal display being capable of turning a transmissive area covering at least part of the multiplication display area to an opaque area and restoring translucency of the opaque area; and a CPU or display controller to turn at least part of the opaque area to the transmissive area in responsive to the player's operation.

### CROSS REFERENCE TO RELATED APPLICATIONS

This application is based upon and claims the benefits of priority from Japanese Patent Application No. 2006-032533 filed on Feb. 9, 2006, the entire contents of which are incorporated herein by reference.

### FIELD OF THE INVENTION

The present invention relates to a gaming machine, and more specifically it relates to a gaming machine such as a slot machine in which variable display of symbols are conducted.

### RELATED ART

In a gaming machine such as a slot machine having a rotational reel configured with an outer circumferential surface on which an array of symbols is arranged to conduct variable display of the symbols by rotating the rotational reel, various kinds of gaming machines have been invented in which games may develop unpredictably.

By way of example, in order to make the game more unpredictable, a gaming machine having a rotational reel configured with an outer periphery, to which a reel tape characterized in that the reel tape is not transmissive from the front face, but is transmissive from the back face is attached, is proposed (e.g., Japanese unexamined patent application publication No. 2002-136641, paragraphs [0040], [0092], and [0093]. In this gaming machine, a plurality of symbols are printed on the back face of the reel tape, which is pasted on the outer periphery of the rotational reel so that the symbols face inside of the reel. An illuminating device is disposed inside of the rotational reel such that the light from the inside of the rotational reel reaches a player through the reel tape such that the player can visually recognize the symbols when the illuminating device is turned on. Therefore, the symbols become recognizable only when the illuminating device is turned on such that the game with high unpredictability may be provided.

In such a conventional gaming machine as described above, only the gaming machine can control the devices to make the symbols on the reel visually recognizable such that the player cannot make the symbols appear (i.e., visually recognizable) on the reel by the player's direct operation. Therefore, since there may be occasions that the player cannot view the symbols on the reel even the player himself wishes to see the symbols, the player may feel stress or irritation (frustrated or irritated). Also, in such a conventional gaming machine, the player may feel dull in the game since it is not necessary for the player to operate in order to view the hidden symbols.

### SUMMARY OF THE INVENTION

A gaming machine that can perform unpredictable game contents is provided. Such a gaming machine comprises: a rotational reel configured with an array of symbols; a display window provided between the rotational reel and a player; and a first area covering at least part of the display window. In the gaming machine, at least part of a first area in an opaque state may be changed into a transmissive state in responsive to the player's operation.

The gaming machine may further comprise: a contact position detecting device for detecting a contact position of the player on the display window and vicinity thereof. In the gaming machine as described above, a second area of at least part of the first area is switched back to the transmissive state in responsive to the contact position detected by the contact position detecting device.

Here, the first area may be once switched from the transmissive state to the opaque state. The opaque state may mean the non-transmissive state. The second area may be the same area as the first area or may be included in the first area. The second area may be switched back to the transmissive state. Such transition from the transmissive state to the opaque state (or vice versa) may be triggered based on various conditions.

Further features of the present invention, its nature, and various advantages will be more apparent from the accompanying drawings and the following description of the preferred embodiment.

### BRIEF DESCRIPTION OF THE DRAWINGS

FIG. 1 is a perspective view of a slot machine.

FIG. 2 is a longitudinal sectional view of a lower liquid crystal display and a reel.

FIG. 3 is an exploded perspective view of the lower liquid crystal display.

FIG. 4 is a block diagram schematically showing a control system of the slot machine.

FIG. 5 is a block diagram schematically showing a liquid crystal driving circuit of the lower liquid crystal display.

FIG. 6 shows an example of arrays of symbols variably displayed on a variable display part.

FIG. 7 shows an example of arrays of symbols variably displayed on a multiplication display part.

FIG. 8 is a functional block diagram of the control system of the slot machine.

FIG. 9 is a flowchart showing an example of main process.

FIG. 10 is a flowchart showing an example of start acceptance process.

FIG. 11 is a flowchart showing an example of base game process.

FIG. 12 is a flowchart showing an example of lottery process.

FIG. 13 shows an example of a display screen of the lower liquid crystal display before opaque display process is started.

FIG. 14 shows an example of the display screen of the lower liquid crystal display after the opaque process is started.

FIG. 15 is a flowchart showing an example of display control process.

FIG. 16 shows an example of the display screen of the lower liquid crystal display after transmissive process is executed.

FIG. 17 shows another example of the display screen of the lower liquid crystal display after the transmissive process is executed.

FIG. 18 is a flowchart showing an example of bonus game process.

FIG. 19 is a flowchart showing an example of free spin process.

FIG. 20 is a flowchart showing another example of display control process.

FIG. 21 shows an example of configuration of the transparent touch panel.

FIG. 22 illustrates a multiplication display part of the lower liquid crystal display concerning the transmissive process.

FIG. 23A shows schematically a state of touching the transparent touch panel.

FIG. 23B shows schematically a state of touching the transparent touch panel more strongly.

FIG. 24 is a drawing showing summarized features of transparent touch panels by the kind.

### DESCRIPTION OF THE PREFERRED EMBODIMENT

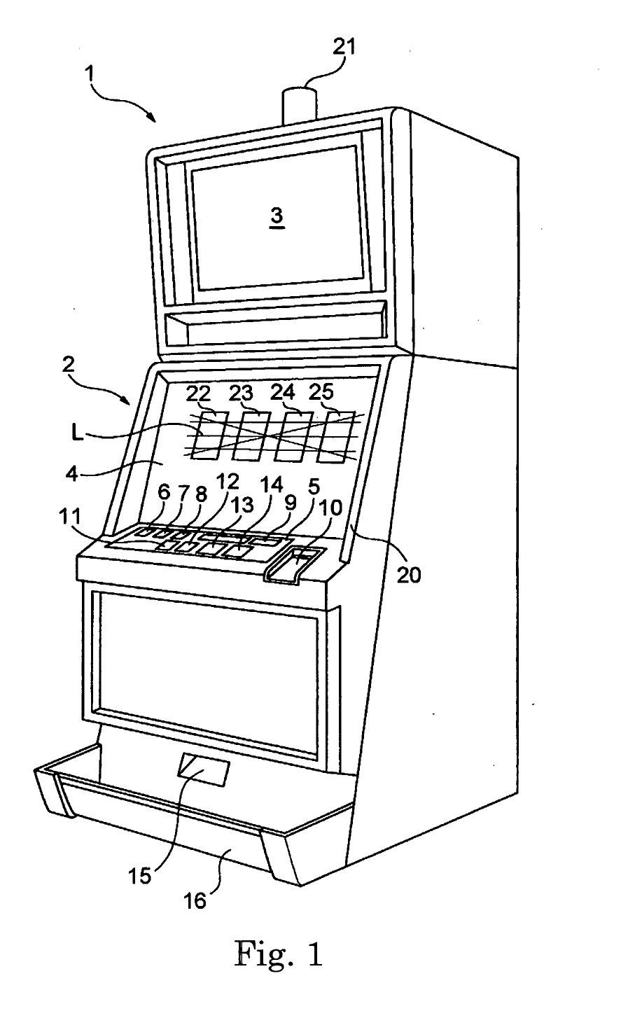

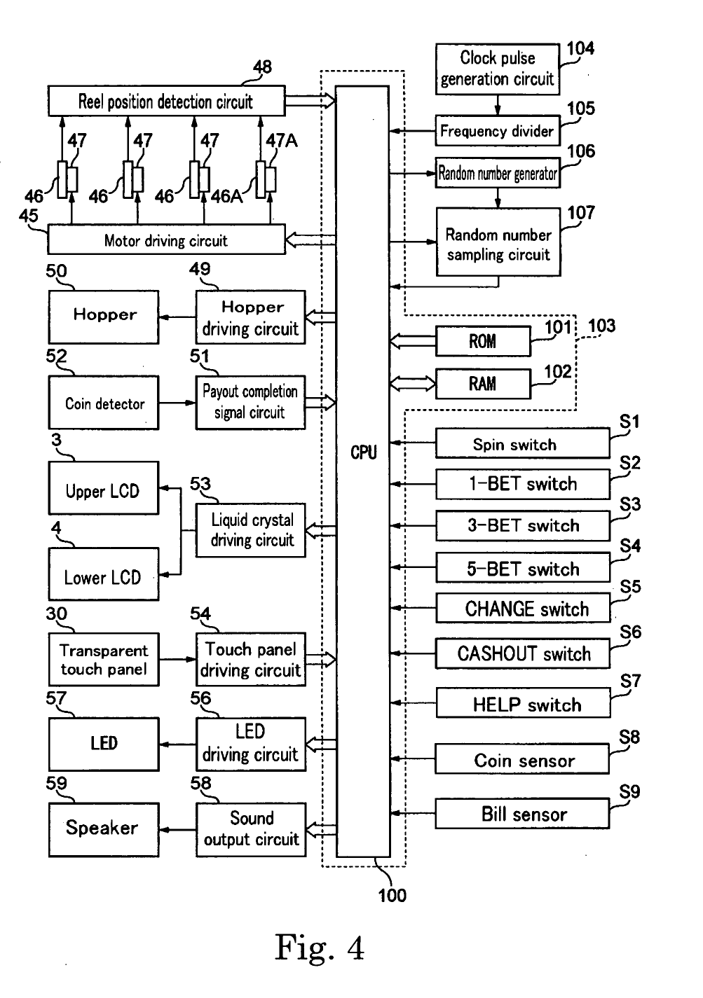

In the following, to describe a gaming machine related to the present invention, an explanation is made in detail, by way of example, for a slot machine as an embodiment of the present invention. First, a schematic configuration of the slot machine related to the present embodiment is described based on FIGS. 1 and 4. FIG. 1 is a perspective view of the slot machine. FIG. 4 is a block diagram schematically showing a control system of the slot machine.

[1. External Configuration of Slot Machine]

As shown in FIG. 1, a slot machine 1 has a cabinet 2 which forms a general outer shape thereof and a lamp 21 is arranged on the upper surface of the cabinet 2. An upper liquid crystal display 3 is arranged on a front and upper part of the cabinet 2, and a lower liquid crystal display 4 corresponding to a display control means of the present invention is arranged on a front and central part of the cabinet 2. The upper liquid crystal display 3 comprises a liquid crystal display which is generally used, and the lower liquid crystal display 4 comprises a so-called transparent liquid crystal display. The upper liquid crystal display 3 displays information regarding a game, such as a game playing method, kinds of winning combinations and payout rates thereof, and various kinds of effects about the game.

Also, as shown in FIG. 1, variable display parts 22, 23 and 24 are basically provided on the lower liquid crystal display 4, and variable display is performed in each of the variable display parts 22 to 24 so that various kinds of identification symbols formed on each reel 46 (refer to FIG. 4) to be described later may scroll down from top to bottom as the reel 46 rotates. A multiplication display part 25 is provided on the left of the variable display part 24. The multiplication display part 25 corresponds to a display window according to the embodiment of the present invention, the reel 46 corresponds to a rotational reel according to the embodiment of the present invention, and in more detail to a rotational reel for display of a winning combination, and a reel 46A corresponds to a rotational reel according to the embodiment of the present invention, and in more detail to a rotational reel for an effect.

In the multiplication display part 25, the variable display of various kinds of multiplication symbols formed on each reel 46A (refer to FIG. 4) to be described later is performed so that they may scroll down from above with the rotation of the reel 46A. A detailed structure of the lower liquid crystal display 4 is described later.

An operation table 5 projecting toward a player's side is provided on the lower part of the lower liquid crystal display 4, and an exchange (EXCHANGE) button 6, a payout (CASHOUT) button 7, and a help (HELP) button 8 are arranged on the operation table 5 from the leftmost side. Further, a coin insertion part 9 and a bill insertion part 10 are provided on the right side of the help button 8. A 1-BET button 11, a SPIN/REPEAT BET button 12, a 3-BET button 13, and a 5-BET button 14 are arranged in order from the left side on the player's side of the operation table 5. The exchange button 6 is a button for turning on the lamp 21. An exchange (CHANGE) switch S6 is attached to the exchange button 6, and a switch signal is outputted from the exchange switch S6 to a CPU 100 based on the depression of the exchange button 6.

A payout button 7 is a button pressed at the end of a base game, and when the payout button 7 is pressed, coins gained in the game are paid out from a coin payout opening 15 to a coin receiving part 16. A payout (CASHOUT) switch S6 is attached to the payout button 7, and a switch signal is outputted to the CPU 100 based on the depression of the payout button 7. The help button 8 is a button pressed when the operating methods of the game or the like are not clear, and when the help button 8 is pressed, various kinds of help information are displayed on the upper liquid crystal display 3 or the lower liquid crystal display 4. A help (HELP) switch S7 is attached to the help button 8, and a switch signal is outputted from the help switch S7 to the CPU 100 based on the depression of the help button 8.

A coin sensor S8 is arranged in the coin insertion part 9, and when a coin is inserted into the coin insertion part 9, a coin detection signal is outputted to the CPU 100 via the coin sensor S8. A bill sensor S9 is arranged in the bill insertion part 10, and when a bill is inserted into the bill insertion part 10, a bill detection signal is outputted to the CPU 100 via the bill sensor S9. The 1-BET button 11 is a button for placing one bet whenever the button is pressed once. A 1-BET switch S2 is attached to the 1-BET button 11, and when the 1-BET button 11 is pressed, a switch signal is outputted from the 1-BET switch S2 to the CPU 100 based on the depression thereof. The spin (SPIN/REPEAT BET) button 12 is a button for starting the variable display of each identification symbol on each of the variable display parts 22 to 24 of the lower liquid crystal display 4, and starting the variable display of the multiplication symbols on the multiplication display part 25 so that a game should be started by a present bet number or a previous bet number based on a depression. A spin switch S1 is attached to the spin button 12, and when the spin button 12 is pressed, a switch signal is outputted from the spin switch S1 to the CPU 100 based on the depression thereof. As the number of bets which can be placed by the depressions of the spin button 12, 1, 2, 3, 4, and 5 bets may exist.

The 3-BET button 13 is a button for starting a game with three bets based on the depression thereof. A 3-BET switch S3 is attached to the 3-BET button 13, and a switch signal is outputted from the 3-BET switch S3 to the CPU 100 at the time of the depression thereof. The 5-BET button 14 is a button for starting a game with five bets based on the depression thereof. A 5-BET switch S4 is attached to the 5-BET button 14, and a switch signal is outputted from the 5-BET switch S4 to the CPU 100 based on the depression thereof. The coin payout opening 15 is formed in the lower part of the cabinet 2, and the coin receiving part 16 for receiving coins paid out from the coin payout opening 15 is provided thereto. A coin detection part 52, to be described later, comprising a sensor and the like is arranged inside the coin payout opening 15, and detects the number of coins paid out from the coin payout opening 15.

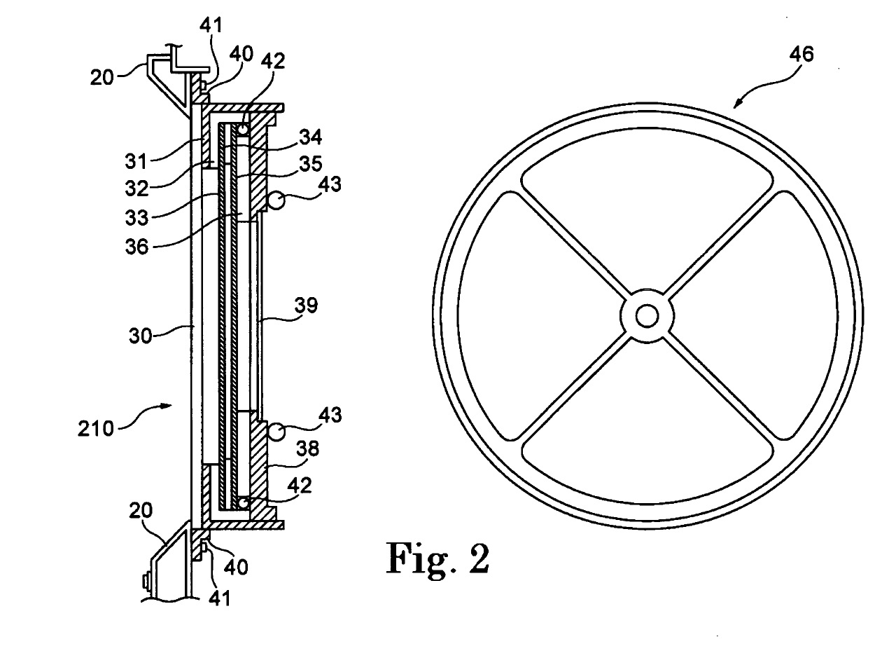

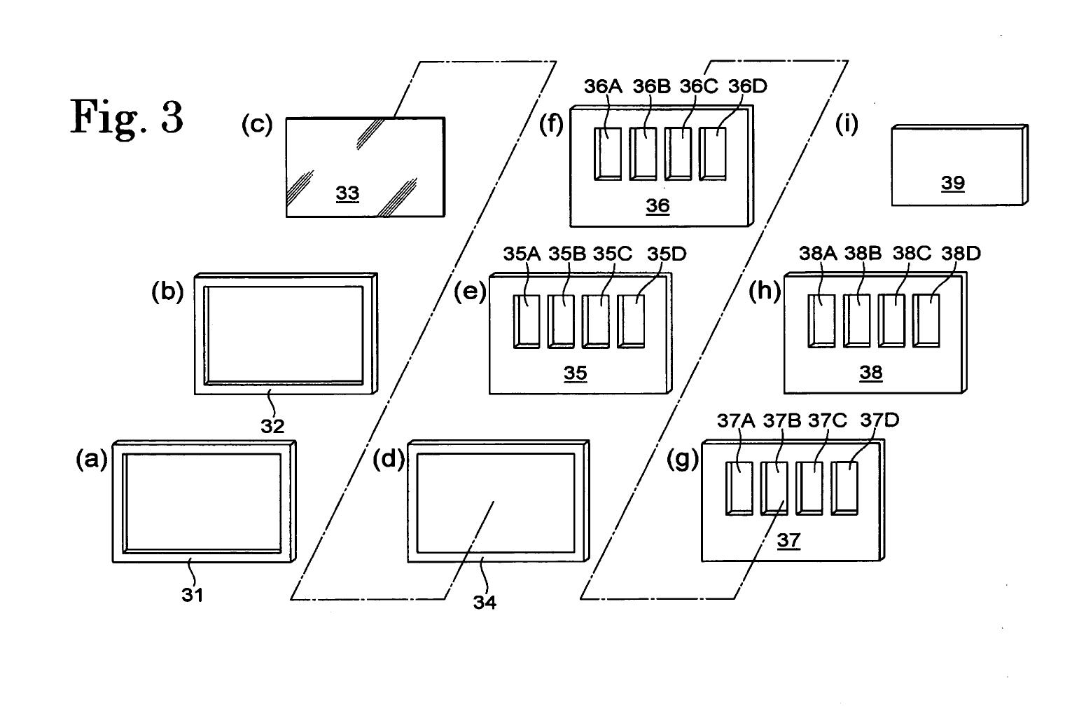

Next, a detailed structure of the lower liquid crystal display 4 and a reel rotatably provided in the cabinet 2 on the back side of the lower liquid crystal display 4 are described based on FIGS. 2 and 3. FIG. 2 is a longitudinal sectional view of the lower liquid crystal display and the reel, and FIG. 3 is an exploded perspective view of the lower liquid crystal display. In FIGS. 2 and 3, the lower liquid crystal display 4 is arranged inside the display window part 210 of a machine front panel 20 provided at the front central part of the cabinet 2 of the slot machine 1 with a transparent touch panel 30 arranged at the front face side (left side in FIG. 2). Three reels 46 (only one reel 46 is illustrated in FIG. 2) having the identification symbols disposed on the outer circumferential surface, and the reel 46A having the multiplication symbols disposed on the outer circumferential surface are supported in parallel and in an independently rotatable way on the back side (i.e., right side in FIG. 2) of the lower liquid crystal display 4. That is, as shown in FIG. 2, the lower liquid crystal display 4 is arranged on the front side of the three reels 46 for performing the variable display of the identification symbols, and the reel 46A for performing the variable display of the multiplication symbols. Then, a base game, to be described later, is played by utilizing the reels 46 and 46A which can be seen through the lower liquid crystal display 4.

Here, an explanation is made for each reel 46. The reel 46 on the left side, if viewed from the front of the slot machine 1, among the three reels 46 is opposed to the variable display part 22 (refer to FIG. 1) formed in the lower liquid crystal display 4, the reel 46 at the center is opposed to the variable display part 23 (refer to FIG. 1) similarly formed in the lower liquid crystal display 4, and the reel 46 on the right side is opposed to the variable display part 24 (refer to FIG. 1) similarly formed in the lower liquid crystal display 4. The configuration of each of the variable display parts 22 to 24 is described later.

Next, the structure of the lower liquid crystal display 4 is described based on FIGS. 2 and 3. In FIGS. 2 and 3, the lower liquid crystal display 4 comprises, from the front face side of the slot machine 1, the transparent touch panel 30 corresponding to a contact position detecting means of the present invention, a reel glass base 31, a bezel metal frame 32, a liquid crystal panel 33, a liquid crystal holder 34, a diffusion sheet 35, a light guide plate 36, a white reflector 37, a rear holder 38, and an antistatic sheet 39. Openings 35A, 35B, 35C, and 35D are formed in the diffusion sheet 35, and similarly, openings 36A, 36B, 36C, and 36D, openings 37A, 37B, 37C, and 37D, and openings 38A, 38B, 38C, and 38D are formed in the light guide plate 36, the reflector 37 and the rear holder 38, respectively, so that they correspond to the openings 35A to 35D. The openings 35A to 38A are overlaid such that they coincide with each other to form the variable display part 22 (refer to FIG. 1), and similarly, the openings 35B to 38B form the variable display part 23 (refer to FIG. 1), and the openings 35C to 38C form the variable display part 24 (refer to FIG. 1). The openings 35A to 35D of the diffusion sheet 35 and the openings 36A to 36D of the light guide plate 36 form a transmissive area for securing visibility of the respective variable display parts 22 to 24 and the multiplication display part 25.

The lower liquid crystal display 4 is mounted to the display window part 210 of the machine front panel 20 by screwing each bracket 40 projecting above and below the reel glass base 31 onto the back surface of the machine front panel 20 with screws 41, as shown in FIG. 2. A pair of cathode ray tubes 42 are provided at the upper and lower ends of the light guide plate 36 as the light source of the liquid crystal panel 33. A pair of cold cathode ray tubes 43 which illuminate the symbols formed on the outer circumferential surface of each reel 46 are provided on the back upper and lower sides of the respective openings 38A to 38D of the rear holder 38. The liquid crystal panel 33 is a transparent electric display panel which is arranged in front of each reel 46, composed of ITO and the like, and allows each reel to be viewed through, and the back side around the display part is held by the liquid crystal holder 34. The light guide plate 36 comprises a light transmissive resin panel, and a lens cut is formed for guiding light emitted from the cold cathode ray tubes 42 located in the side parts to the back side of the liquid crystal panel 33. The diffusion sheet 35 comprises a light transmissive resin sheet, diffuses the light guided by the light guide plate 36 to uniformize light emitted to the liquid crystal panel 33. The liquid crystal holder 34 holding the liquid crystal panel 33, the diffusion sheet 35, and the light guide plate 36 are integrated (assembled in a single body), and the circumference of the thus-integrated body is inserted into the bezel metal frame 32. Through this insertion, the front side of the circumference of the display part in the liquid crystal panel 33 is supported by the bezel metal frame 32.

The circumference of the liquid crystal holder 34, the diffusion sheet 35, and the light guide plate 36 which are fitted in the bezel metal frame 32 and integrated into a single body is further inserted in the reel glass base 31, and held by the reel glass base 31 in a state where the display front of the liquid crystal panel 33 is opened. By mounting the reel glass base 31 to the machine front panel 20 by means of the screws 41, the transparent touch panel 30 is press-contacted with the front of the reel glass base 31, and stacked on the front of the display part of the liquid crystal panel 33. The rear holder 38 comprises a white resin plate, and holds the bezel metal frame 32 supported by the reel glass base 31, the liquid crystal holder 34 holding the liquid crystal panel 33, the diffusion sheet 35, and the light guide plate 36 to the reel glass base 31 from behind. This rear holder 38 functions also as a reflector plate for reflecting the light emitted from the cold cathode ray tubes 42 to the light guide plate 36 toward the liquid crystal panel 33. The antistatic sheet 39 is transparent, bonded to the back of the rear holder 38 with a double-sided tape, and covers the back of the individual openings 38A to 38D (refer to FIG. 3) formed in the rear holder 38.

In the above configuration around the lower liquid crystal display 4, the pair of cold cathode ray tubes 43 are provided for illuminating the symbols formed on the outer circumferential surfaces of the respective reels 46 and 46A. However, a change into the following configuration may be made.

That is, in the configurations shown in FIGS. 2 and 3, the pair of cold cathode ray tubes 43 for illuminating the outer circumferential surfaces of the respective reels 46 and 46A are not provided. Instead, part of light emitted from the cold cathode ray tubes 42 to the light guide plate 36 is made to be guided to the openings 36A, 36B, 36C, and 36D. Light scattering processed surfaces are formed on the end surfaces of the openings 36A, 36B, 36C, and 36D, and the guided light is emitted from the light scattering processed surfaces. As a result, the outer circumferential (or peripheral) surfaces of the respective reels 46 and 46A are irradiated with the light emitted from the light scattering processed surfaces.

In the above configuration without using the cold cathode ray tubes 43, such a configuration may be adopted that recesses are formed on the light guide plate 36 instead of the openings 36A, 36B, 36C, and 36D, and form light scattering surfaces on the recesses.

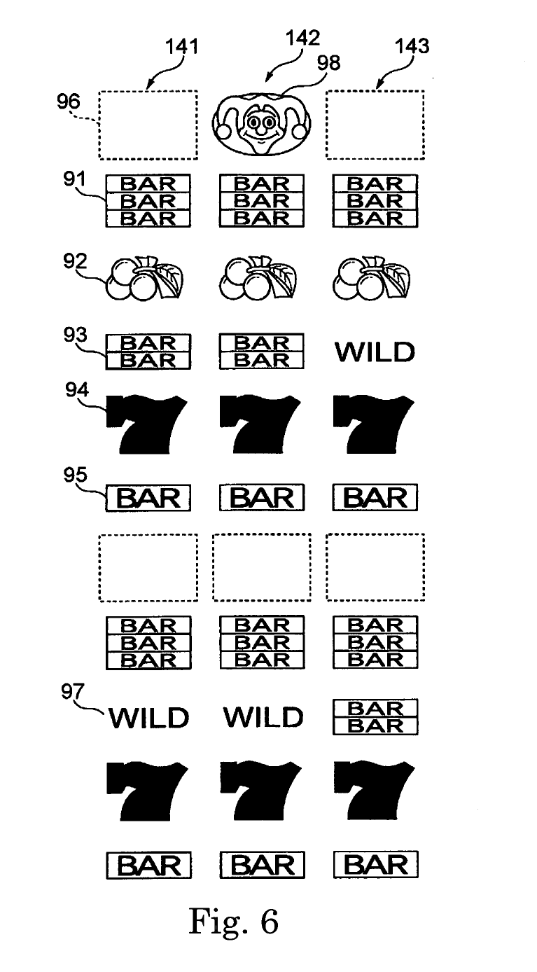

Now, various kinds of identification symbols used in the game as shown in FIG. 6 are formed on the outer circumferential surface of each reel 46. FIG. 6 shows arrays of symbols formed on the outer circumferential surfaces of the respective reels 46, and variably displayed while scrolling in the respective transparent variable display parts 22 to 24 of the lower liquid crystal display 4 during the base game. In FIG. 6, an array of symbols 141 is variably displayed in the variable display part 22, an array of symbols 142 is variably displayed in the variable display part 23, and an array of symbols 143 are variably displayed in the variable display part 24. The arrays of symbols 141 and 143 have symbol arrangements, and each array of symbols thereof comprises 11 symbols including a triple BAR 91, a CHERRY 92, a double BAR 93, a SEVEN 94, a single BAR 95, a BLANK (region where no symbol exists) 96, and a WILD 97, which are properly combined in the number of symbols of each kind and in the order of each array to make the 11 symbols. The WILD 97 is the so-called almighty symbol or wild card, and substitutes for any kinds of symbols of the triple BAR 91, the CHERRY 92, the double BAR 93, the SEVEN 94, and the single BAR 95.

Although the array of symbols 142 is similar to the arrays of symbols 141 and 143 as far as the triple BAR 91, the CHERRY 92, the double BAR 93, the SEVEN 94, and the single BAR 95, and the BLANK 96 are combined, one trigger symbol 98 is further arranged in replacement of any one of the other kinds of symbols. The trigger symbol 98 is a symbol for shifting to a bonus game as described later, and when the trigger symbol 98 is stopped and displayed along an activated pay line L in the variable display part 23, the game can shift to the bonus game.

In a usual technique for forming various identification symbols on the outer circumferential surface of each reel 46, eleven symbols are printed on a long reel sheet (or a trip of paper) with width and length thereof corresponding to the width and the circumferential length of each reel 46, and the identification symbols are formed by sticking the reel sheet on the curved surface of each reel 46. However, it is obviously possible to form the identification symbols by methods other than this method.

When the arrays of symbols 141 to 143 having been scrolled in the respective variable display parts 22 to 24 are stopped and displayed, three identification symbols are stopped and displayed on the respective variable display parts 22 to 24. Various kinds of winning combinations are preset based on a plurality of types of combinations of respective identification symbols, and when the combination of identification symbols corresponding to the winning combination stops and appears along the activated pay line L, coins are paid out from the coin payout opening 15 according to the winning combination. In this point, the present gaming machine operates in the same way as the conventional slot machine, and a description thereof is omitted here.

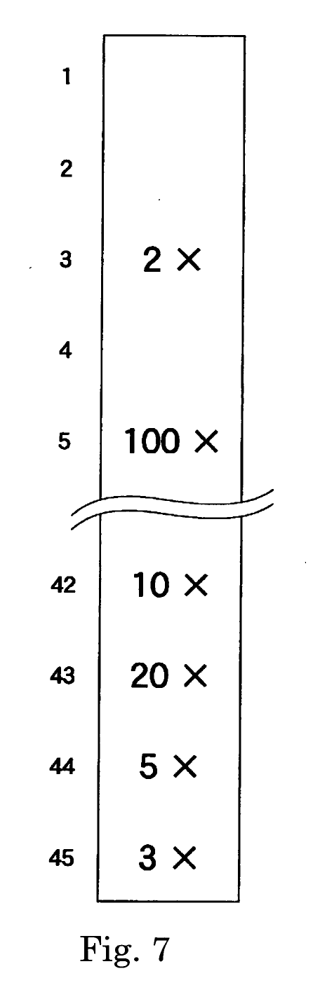

Various kinds of multiplication symbols used in the game as shown in FIG. 7 are formed on the outer circumferential surface of the reel 46A. FIG. 7 shows an array of multiplication symbols formed on the outer circumferential surface of the reel 46A, and variably displayed while scrolling in the transparent multiplication display part 25 of the lower liquid crystal display 4 during the game. The array of multiplication symbols comprises 45 symbols in which multiplication symbols indicating twice, three times, five times, ten times, twenty times, and one hundred times, respectively, are combined suitably. When a winning combination is completely shown along the activated pay line L, a payout for the winning combination is multiplied by a multiplication factor corresponding to a multiplication symbol displayed along the extension of the activated pay line L to determine the payout amount to be paid out to the game player. The multiplication symbols correspond to the “symbols other than symbols to determine the winning combination” of the present invention.

[2. Example of Control System Configuration of Slot Machine]

Next, a configuration related to a control system of the slot machine 1 is described based on FIG. 4. FIG. 4 is a block diagram schematically showing the control system of the slot machine. In FIG. 4, the control system of the slot machine 1 is basically composed of a microcomputer 103 as a core member comprising a CPU 100, a ROM 101, and a RAM 102, and the ROM 101 and the RAM 102 are connected to the CPU 100. The ROM 101 stores various kinds of programs, data tables, and the like for executing a necessary processing for the control of the slot machine 1, such as main process, start acceptance process, lottery process, base game process, display control process, bonus game process, and free spin process, which are described later. The RAM 102 is a memory for temporarily storing various kinds of data calculated by the CPU 100.

A clock pulse generating circuit 104 which generates a reference clock pulse, and a frequency divider 105 are connected to the CPU 100, and a random number generator 106 which generates random numbers, and random number sampling circuit 107 are also connected thereto. Random numbers sampled via the random number sampling circuit 107 are used for various kinds of lotteries of winning combinations and the like, and the lottery of the multiplication symbols. Further, each of the spin switch S1 attached to the spin (SPIN/REPEAT BET) button 12, the 1-BET switch S2 attached to the 1-BET button 11, the 3-BET switch S3 attached to the 3-BET button 13, the 5-BET switch S4 attached to the 5-BET button 14, an exchange (CHANGE) switch S5 attached to the exchange button 6, the payout (CASHOUT) switch S6 attached to the payout button 7, and the help (HELP) switch S7 attached to the help button 8 is connected to the CPU 100. The CPU 100 executes control for performing various kinds of operations corresponding to the respective buttons based on the switch signals outputted from the respective switches by the depression of the respective buttons.

Stepping motors 47 and 47A which rotate the respective reels 46 and 46A via a motor driving circuit 45 are connected to the CPU 100, and a reel position detection circuit 48 is also connected thereto. When a motor drive signal is outputted from the CPU 100 to the motor driving circuit 45, each of the stepping motors 47 and 47A is rotated by the motor driving circuit 45. Thus, each of the reels 46 and 46A is rotated. After rotation of the reels 46 and 46A is started, the number of the driving pulses supplied to each of the stepping motors 47 and 47A is calculated, and the calculated values are written in a prescribed area of the RAM 102. Reset pulses are outputted from each of the reels 46 and 46A for every single revolution, and are inputted into the CPU 100 via the reel position detection circuit 48. Thus, when the reset pulses are inputted into the CPU 100, the calculated values written in the RAM 102 are cleared to be “0”, and the CPU 100 detects the rotation positions of the symbols in each of the reels 46 and 46A based on calculated values corresponding to the rotation positions within the single revolution of the respective reels 46 and 46A, and a symbol table which associates the rotation positions of the respective reels 46 and 46A stored in the ROM 101 with the symbols formed on the outer circumferential surfaces of the respective reels 46 and 46A.

The coin sensor S8 arranged in the coin insertion part 9 and the bill sensor S9 arranged in the bill insertion part 10 are connected to the CPU 100, separately. The coin sensor S8 detects coins inserted from the coin insertion part 9, and the CPU 100 calculates the number of inserted coins based on a coin detection signal outputted from the coin sensor S8. The bill sensor S9 detects the denomination and the sum of bills inserted from the bill insertion part 10, and the CPU 100 calculates the number of coins equivalent to the sum of bills based on a bill detection signal outputted from the bill sensor S9.

A hopper 50 is connected to the CPU 100 via a hopper driving circuit 49. When the CPU 100 outputs a driving signal to the hopper driving circuit 49, the hopper 50 pays out the predetermined number of coins from the coin payout opening 15. A coin detector 52 is connected to the CPU 100 via a payout completion signal circuit 51. The coin detector 52 is arranged inside the coin payout opening 15, and outputs a coin payout detection signal to the payout completion signal circuit 51 when it is detected that the predetermined number of coins are paid out from the coin payout opening 15. The payout completion signal circuit 51 outputs a payout completion signal to the CPU 100 on receiving the signal. Further, the upper liquid crystal display 3 and the lower liquid crystal display 4 are connected to the CPU 100 via a liquid crystal driving circuit 53, and controlled by the CPU 100.

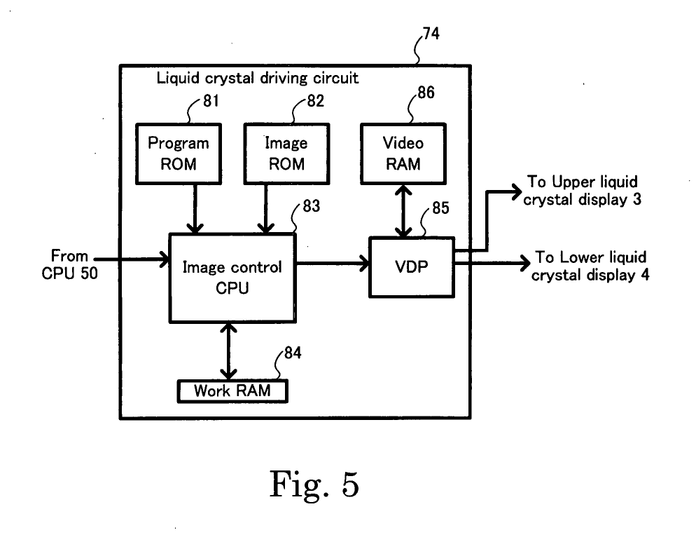

Regarding this point, the liquid crystal driving circuit 53 comprises a program ROM 81, an image ROM 82, an image control CPU 83, a work RAM 84, a VDP (video display processor) 85, a video RAM 86, and the like, as shown in FIG. 5. The program ROM 81 stores a program for image control and various selection tables regarding display on the upper liquid crystal display 3 and the lower liquid crystal display 4. The image ROM 82 stores dot data for forming an image, such as dot data for forming an image in the upper liquid crystal display 3 or the lower liquid crystal display 4, for example. The image control CPU 83 determines an image to be displayed on the upper liquid crystal display 3 or the lower liquid crystal display 4 from the dot data stored in advance in the image ROM 82 based on parameters set by the CPU 100, and according to an image control program stored in advance in the program ROM 81. The work RAM 84 is configured to be a temporary storage means when the image control CPU 83 executes the image control program. The VDP 85 generates image data corresponding to a display content determined by the image control CPU 83, and outputs the generated data to the upper liquid crystal display 3 or the lower liquid crystal display 4. The Video RAM 86 is configured to be a temporary storage means when the VDP 85 forms an image.

A LED 57 is connected to the CPU 100 via a LED driving circuit 56. A number of LEDs 57 are arranged on the front of the slot machine 1, and light control thereof is performed by the LED driving circuit 56 based on a driving signal transmitted from the CPU 100 when performing various kinds of representations. Further, a sound output circuit 58 and a speaker 59 are connected to the CPU 100, and the speaker 59 produces various kinds of sound effects when performing various kinds of effects based on output signals transmitted from the sound output circuit 58.

Also, the lamp 21 is connected to the CPU 100 via a lamp driving circuit (not shown). The lamp 21 is arranged on the upper surface of the slot machine 1 (refer to FIG. 1), and when the exchange button 6 is pressed, light control is performed by the lamp driving circuit based on a driving signal transmitted from the CPU 100.

The transparent touch panel 30 is connected to the CPU 100 via a touch panel driving circuit 54. The transparent touch panel 30 is mounted on the screen of the lower liquid crystal display 4, outputs coordinate position information of a contact portion contacted by the game player via the touch panel driving circuit 54, and allows the CPU 100 to locate the contact position of the game player.

When performing the base game or the bonus game on the slot machine 1, the CPU 100 determines by lottery identification symbols which are stopped and displayed along the activated pay line L. The CPU 100 performs the stop control of each of the left, center, and right reels 46 so that the identification symbols determined by the lottery stop and appear along the activated pay line L. The game player can visually recognize each of the identification symbols disposed on the three reels 46 via the three variable display parts 22 to 24, through which the game player can see the symbols. Here, the identification symbols visually recognized by the game player through the three variable display parts 22 to 24 after the variable display is terminated and the symbols are shown statically may be referred to as “stopped identification symbols”.

The array of symbols is provided on the outer circumferential surface of each of the three reels 46 in left, center, and right as mentioned above. FIG. 6 shows an example of arrays of symbols 141, 142, and 143 provided on each of the left, center, and right reels 46.

The arrays of symbols 141, 142, and 143 are formed of 11 identification symbols, respectively. There are eight types of identification symbols included in the array of symbols, that is, the “3-BAR” symbol 91, the “CHERRY” symbol 92, the “2-BAR” symbol 93, the “SEVEN” symbol 94, the “BAR” symbol 95, the “BLANK” symbol 96, the “WILD” symbol 97, and the bonus symbol 98 which is the bonus game trigger.

The lottery of the stopped identification symbols is performed by using random numbers sampled by the CPU 100 via the random number sampling circuit 107. On the other hand, a lottery table which describes the correspondence relationship of the combination between random numbers and stopped identification symbols is prepared, and the CPU 100 compares the lottery table with the random numbers obtained by the sampling, and determines a stopped identification symbol.

Although a method for determining the stopped identification symbols of three reels 46 in left, center, and right at once by using a single random number is adopted in the present embodiment, such a method may also be adopted in which one random number is sampled for each of the three reels 46 in left, center, and right, and a stopped identification symbol is determined for each reel 46.

Further, when the base game and the bonus game are performed on the slot machine 1, the CPU 100 determines a multiplication symbol to be stopped and displayed statically in the multiplication display part 25 by lottery. The CPU 100 performs the stop control of the reel 46A so that a multiplication symbol determined by the lottery stops in the multiplication display part 25. The game player can visually recognize the multiplication symbol disposed on the reel 46A through the multiplication display part 25. Unless a region corresponding to the multiplication display part 25 of the lower liquid crystal display 4 is in a transmissive state, it becomes impossible for the game player to visually recognize the multiplication symbol. However, when the game player touches any place of an opaque area on the transparent touch panel 30 with the finger or the like as the touch panel 30 is in an opaque state, part or all of the opaque area is changed to a transmissive state corresponding to a touched position, and the game player can visually recognize the multiplication symbol.

The multiplication symbol visually recognized by the game player through the multiplication display part 25 in a state where the variable display is terminated and the symbols are shown statically may be referred to as a “stopped multiplication symbol”.

The lottery of the stop multiplication symbols is performed by using random numbers sampled by the CPU 100 via the random number sampling circuit 107. A lottery table indicating the correspondence relationship of the combination between the random numbers and the stopped multiplication symbols is prepared in advance, and the CPU 100 compares the lottery table with a random number obtained by the sampling, and determines a stopped multiplication symbol.

Next, winning combinations and the payouts thereof for a case where the slot machine 1 performs the base game by using the three variable display parts 22 to 24 and the multiplication display part 25 are described.

In the present embodiment, it is determined whether or not a winning combination is won, and which combination is won when the winning combination is won. The CPU 100 determines whether to conduct the payout or not and how many coins to be paid out, that is, a payout amount if the payout is conducted in accordance with a winning combination and a payout table prepared in advance based on the random number for determining a stopped symbol.

[3. Example of Functions of the Control System of Slot Machine]

The functions of the slot machine 1 related to the present embodiment are achieved when the microcomputer 103, more specifically the CPU 100, executes the programs mainly stored in the ROM 101. In the following, various functions achieved when the microcomputer 103, more specifically the CPU 100, executes the programs are described.

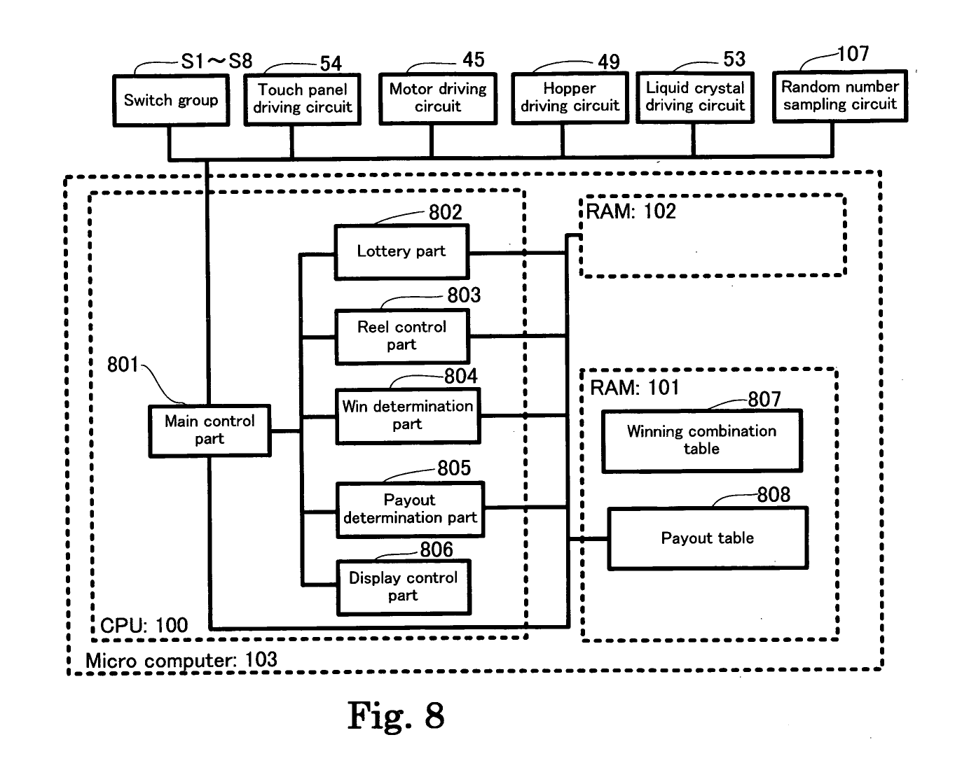

FIG. 8 shows a functional block diagram of the slot machine 1. In an example shown in the drawing, the CPU 100 functions as a main control part 801, a lottery part 802 which is called by the main control part 801 and started, a reel control part 803, a win determination part 804, a payout determination part 805, and a display controller 806.

[3.1. Main Control Part]

The main control part 801 integrally controls each circuit, and the operation of each part in the slot machine 1. More specifically, the main control part 801 receives each input signal from the coin sensor S8, the spin switch S1, the 1-BET switch S2, the 3-BET switch S3, the 5-BET switch S4, the exchange (CHANGE) switch S5, the CASHOUT switch S6, the HELP switch S7, the coin sensor S8, the bill sensor S9 (S1 to S9 are collectively referred to as “switch group”), and the touch panel driving circuit 54, starts each part according to the received input signal, and instructs each part to perform processes corresponding to the input signal.

The main control part 801 acquires a random number value from the random number sampling circuit 107 according to a request from the lottery part 802, and passes the random number value to the lottery part 802. The main control part 801 transmits image generation instructions to the liquid crystal driving circuit 53 so that a screen corresponding to the operation of each part is displayed on the upper liquid crystal display 3 and/or the lower liquid crystal display 4.

When the game player presses the CASHOUT button or the like, the main control part 801 transmits coin payout instructions to the hopper driving circuit 49 under predetermined conditions, and causes the payout of coins. Further, in order to perform effects corresponding to the operations of respective parts, drive instructions are transmitted to the LED driving circuit 56 and the sound output circuit 58 to cause the LED 57 and the speaker 59 to perform the effects.

[3.2. Lottery Part, Reel Control Part, Win Determination Part, Payout Determination Part, and Display Controller]

The functions of the lottery part 802, the reel control part 803, the win determination part 804, and the payout determination part 805, which are controlled by the main control part 801, are as follows.

The lottery part 802 has a function to determine a random number for determining a stopped identification symbol and a stopped multiplication symbol in response to the start of the game.

The reel control part 803 has a function to control the movement and the stop of the reels 46 and 46A so that a stopped identification symbol and a stopped multiplication symbol which are determined by the lottery part 802 stop within the variable display parts 22, 23, and 24 and the multiplication display part 25.

The win determination part 804 has a function to determine whether or not a predetermined combination is achieved on the pay line based on a random number determined by the lottery part 802, or the stopped identification symbols of the reels 46 stopped by the reel control part 802.

The payout determination part 805 has a function to determine a value of the payout amount to be paid out to the game player, based on a stopped multiplication symbol displayed in the multiplication display part 25 and at a position corresponding to the pay line along which a winning combination is won. In the present embodiment, the value of the payout amount is a value obtained by multiplying the payout rate of the winning combination by a multiplication factor indicated by the stopped multiplication symbol located along the extension of the pay line on which the winning combination is won.

The payout determination part 805 calculates the value of the payout amount, and passes the resultant value to the main control part 801. The main control part 801 drives the hopper driving circuit 49 or updates credit values stored in the RAM 102, in accordance with the value.

The display controller 806 executes a display control process to be described later. That is, the display controller 806 controls the liquid crystal driving circuit 53 to make an area corresponding to the multiplication display part 25 in the display area of the lower liquid crystal display 4 into an opaque area. Here, the “opaque area” means that some display process is performed to the area corresponding to the multiplication display part 25 such that the game player cannot visually recognize the multiplication symbols disposed on the reel 46A though the multiplication display part 25. For example, the lower liquid crystal display 4 is caused to perform display in the area such that the area is marked out with predetermined color, pattern, symbol, or the like. Further, the display may not be necessarily performed in a statical display mode, and even a dynamic display may be able to provide the “opaque area”.

When an area corresponding to the multiplication display part 25 in the display area of the lower liquid crystal display 4 is in an opaque state, the display controller 806 drives the liquid crystal driving circuit 53, if a contact or touch is performed, such that the contacted place and a surrounding part thereof are changed to a transmissive area. Here, the “transmissive area” may be an area in a state where the lower liquid crystal display 4 as a transparent liquid crystal panel performs no display performance. It is not necessary that the transmissive area covers the entire area of the multiplication display part 25, but the transmissive area may be formed in such a range that the game player can visually recognize only any one of the three multiplication symbols provided in the multiplication display part 25.

[4. Operational Example of Slot Machine]

Next, an explanation is made for an operational example of the slot machine 1 configured in an aforementioned manner.

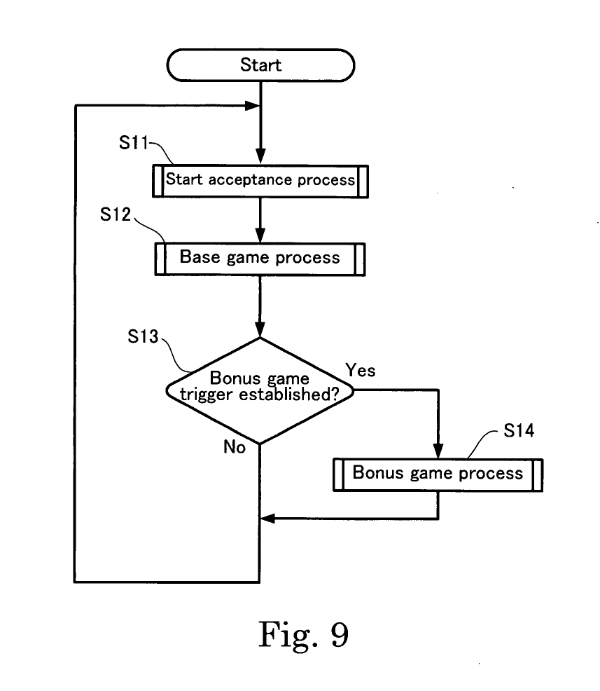

First, an example of main process performed on the slot machine 1 is described based on FIG. 9. FIG. 9 is a flowchart showing an example of the main process.

The slot machine 1 (more specifically, CPU 100) executes a start acceptance process based on the beginning of the main process (S11). The start acceptance process is a processing to receive a switch signal outputted from the spin switch S1, the 1-BET switch S2, the 3-BET switch S3, or the 5-BET switch S4, based on the operation of the spin (SPIN/REPEAT BET) button 12, the operation of the 1-BET button 11, the operation of the 3-BET button 13, or the operation of the 5-BET button 14. A game is started when the switch signal outputted from each switch is received.

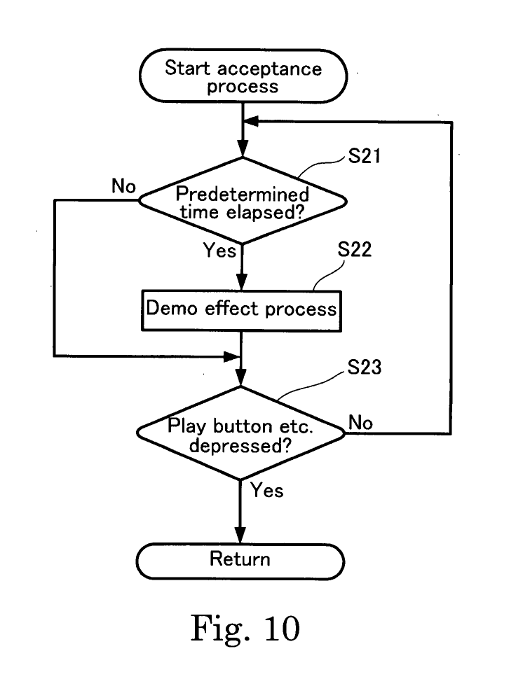

An explanation for a specific example of the aforementioned start acceptance process is made based on FIG. 10. FIG. 10 is a flowchart showing an example of the start acceptance process.

Based on the start of the start acceptance process, the CPU 100 (or the main control part 801) determines first whether a predetermined period of time (for example, 15 seconds) has elapsed or not (S21). When it is determined that the predetermined time has not elapsed (S21, No), the process proceeds to S23 without doing anything, but when it is determined that the predetermined time has elapsed (S21, Yes), a demonstration effect is performed on the upper liquid crystal display 3 or the lower liquid crystal display 4 in S22, and then the process proceeds to S23. When it is determined that the 1-BET button 11 or the like has not been operated (S23, No), the process returns to S21 and repeats the above processes. On the other hand, when it is determined that the 1-BET button 11 or the like has been operated (S23, Yes), the process returns to the main process of FIG. 9 even in the middle of the demonstration effect, and proceeds to base game process in S12.

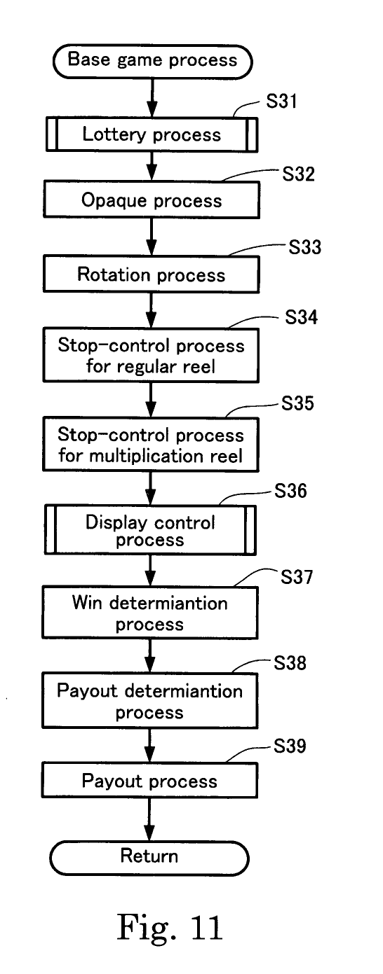

Returning to FIG. 9, the explanation of the main process is continued. The slot machine 1 performs the base game process after completion of the start acceptance process (S11). The contents of the base game process (S12) performed on the slot machine 1 are described with reference to FIG. 11. FIG. 11 is a flowchart showing the base game process.

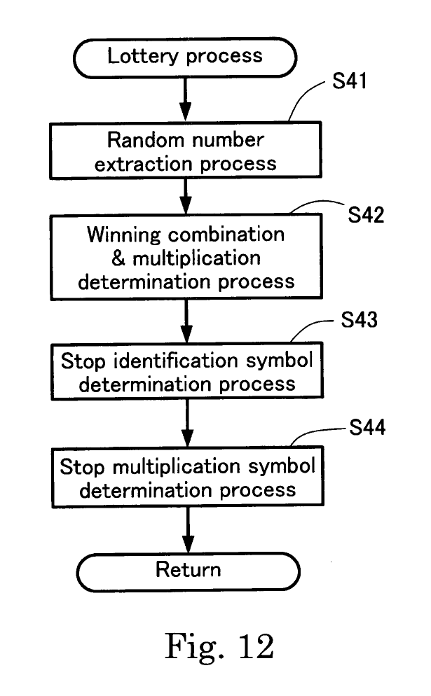

Based on the beginning of the base game process, the CPU 100 (or the lottery part 802) executes the lottery process first (S31). The specific contents of the lottery process (S31) are described based on FIG. 12. FIG. 12 is a flowchart showing an example of lottery process.

First, the CPU 100 (or the lottery part 802) performs random number extraction process (S41). The random number extraction process (S41) is a processing in which the CPU 100 samples one random number via the random number sampling circuit 107.

Following the random number extraction process (S41), the CPU 100 executes combination and multiplication determination process (S42). The combination and multiplication determination process is a processing of comparing the random number extracted in S41 with a winning combination table 807 having been prepared in advance and describing the corresponding relationship between the random numbers and the winning combinations (including so-called losing combinations, with which the player would not gain anything), determining a winning combination corresponding to the extracted random number, and determining a stopped multiplication symbol. The winning combination table 807 is a table indicating, for example, that a winning combination is a “bonus game” when the random number value is any one of 1 to 10, in the same way, that a winning combination is a “three SEVEN” when the random number value is any one of 11 to 40, . . . , and that a winning combination is a “losing combination” when the random number value is any one of 341 to 1024.

Subsequent to the combination and multiplication determination process (S42), the CPU 100 (or the reel control part 803) executes a stop identification symbol determination process (S43). The stop identification symbol determination process (S43) is a processing of determining a symbol to be stopped and displayed statically along the activated pay line L for each of the variable display parts 22 to 24 such that the winning combination determined in the combination determination and multiplication process is won. Specifically, the CPU 100 (or the reel control part 803) determines a code number of a symbol to be stopped for each of the reels 46 such that the winning combination of symbols corresponding to the determined combination is won along the activated pay line L.

Subsequent to the stop identification symbol determination process (S43), the CPU 100 (or the reel control part 803) executes a stop multiplication symbol determination process (S44). The stop multiplication symbol determination process (S44) is a processing of determining a stop multiplication symbol to be stopped and displayed statically on the activated pay line L (or an extension thereof) such that a multiplication factor having been determined in the combination determination and multiplication process is provided to the game player. Specifically, the CPU 100 (or the reel control part 803) determines a code number of the stopped multiplication symbol for the reel 46A such that a multiplication symbol corresponding to the determined multiplication factor stops on the activated pay line L.

The lottery process ends by the completion of the stop multiplication symbol determination process (S44) and the process returns to the base game process of FIG. 11 such that the CPU 100 (or the display controller 806) executes an opaque process (S32). The opaque process (S32) is a processing of changing the area corresponding to the multiplication display part 25 in the display area of the lower liquid crystal display 4 to an opaque area by driving the liquid crystal driving circuit 53.

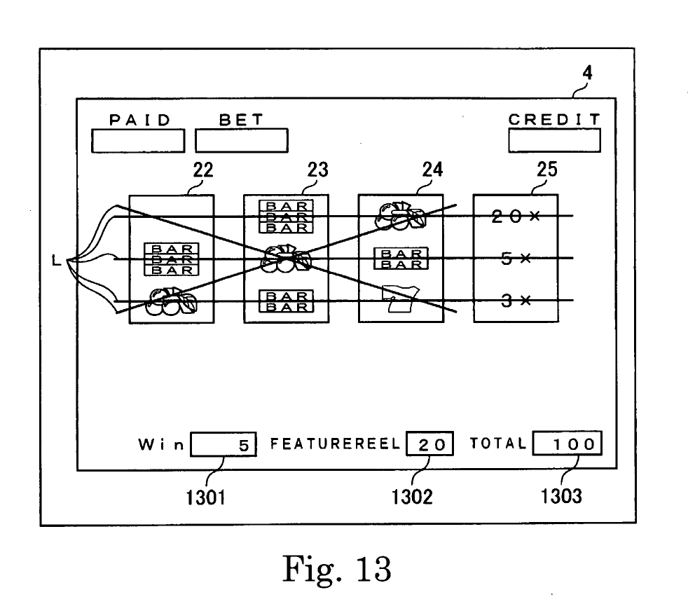

FIG. 13 shows a display example of the lower liquid crystal display 4 showing a state before execution of the opaque process. As described above, the variable display parts 22, 23, and 24 and the multiplication display part 25 are provided in the lower liquid crystal display 4. Stopped identification symbols as the results of the previous game are shown in the variable display parts 22, 23, and 24, and stopped multiplication symbols as the results of the previous game are also shown in the multiplication display part 25.

A payout display area 1301 indicating the payout of a winning combination, a multiplication display area 1302 displaying the multiplication factor of a multiplication symbol corresponding to the pay line L when a winning combination is won along the pay line, and a payout amount display area 1303 showing a value of the payout amount to be paid out to the game player which is a product of the value displayed in the payout display area 1301 and a value displayed in the multiplication display area 1302 are provided in the lower part of the lower liquid crystal display 4. These areas 1301 to 1303 are video images displayed by the lower liquid crystal display 4.

In the example shown in FIG. 13, the multiplication display part 25 is not yet changed to the opaque area and the multiplication symbols can be recognized visually in the multiplication display part 25 accordingly.

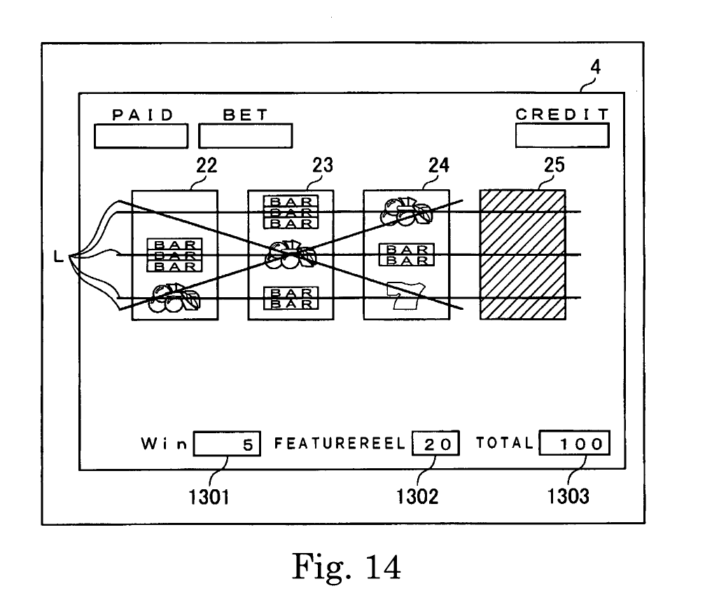

FIG. 14 is a display example of the lower liquid crystal display 4 showing a state after execution of the opaque process. In the example shown in FIG. 14, the multiplication display part 25 is already changed to the opaque area in the opaque process (S32) and it is not possible to visually recognize the multiplication symbols in the multiplication display part 25 accordingly.

Returning to FIG. 11, the explanation of the base game process is continued. The CPU 100 (or the reel control part 803) executes a rotation process after the execution of the opaque process (S33).

In the rotation process, the CPU 100 (or the reel control part 803) first executes the rotation process of starting the rotation of the three reels 46 and the reel 46A in the cabinet 2 (S32) based on the switch signal outputted from the spin switch S1, the 1-BET switch S2, the 3-BET switch S3, or the 5-BET switch S4 wherein the switch signal is first received in the start acceptance process (S11). Respective identification symbols are scrolled in the variable display parts 22 to 24 and multiplication symbols are scrolled in the multiplication display part 25 in the rotation process. At this time, the variable display parts 22 to 24 are left transmissive and hence the game player can visually recognize the scrolling of the identification symbols. However, the game player cannot view the variable display of the multiplication symbols in the multiplication display part 25 which is changed to the opaque area.

Next, the CPU 100 (or the reel control part 803) executes a stop control process for regular reels to stop the rotation of the three reels 46 in the cabinet 2 such that the symbols having been determined in the stop identification symbol determination process (S43) are stopped along the activated line L (S34). The scrolling of respective identification symbols in the variable display parts 22 to 24 is terminated in the stop control process for the regular reels.

Then, the CPU 100 (or the reel control part 803) executes multiplication reel stop control process of stopping the rotation of the multiplication reel 46A in the cabinet 2 such that the multiplication symbol determined in the stop multiplication symbol determination process (S44) is stopped along the activated pay line L (S35). Based on the stop control process for the multiplication reel, the scrolling of the multiplication symbol in the multiplication display part 25 is terminated. In addition, the multiplication display part 25 is changed to the opaque area by the execution of the opaque process (S32) and it is impossible for the game player to view the stopped multiplication symbol accordingly.

After the stop control process for the multiplication reel (S35), the CPU 100 (or the display controller 806) executes a display control process (S36). The display control process is a processing of changing the area corresponding to the multiplication display part 25 in the display area of the lower liquid crystal display 4 to an opaque area, and changing back a touched place and a surrounding part thereof to a transmissive area when the touched place is contacted by the game player while the area corresponding to the multiplication display part 25 in the display area of the liquid crystal display 4 is subjected to the opaque process.

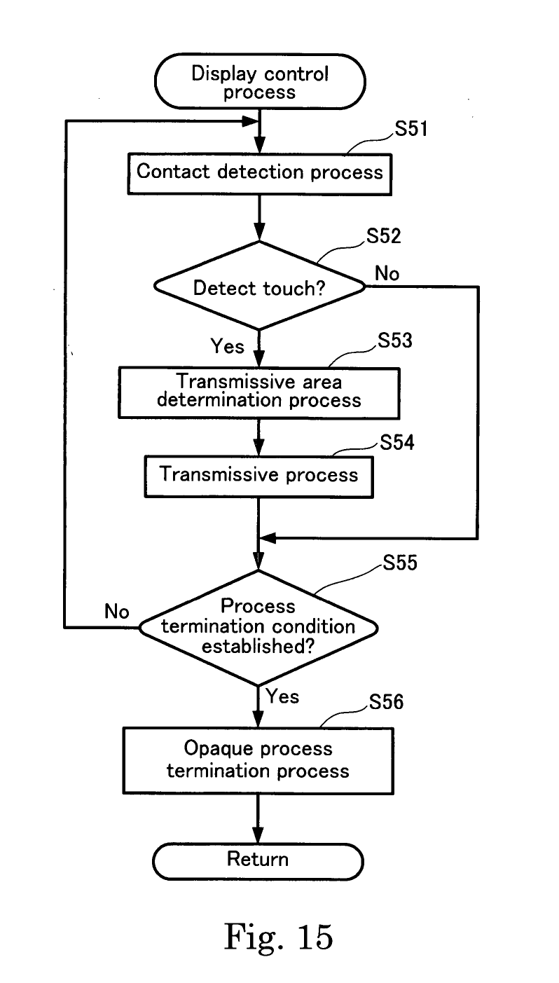

FIG. 15 is a flowchart showing an example of display control process. In the following, the specific contents of the display control process are explained with reference to FIG. 15.

First, the CPU 100 (or the display controller 806) executes a contact detection process (S51).

The slot machine 1 related to the present embodiment enables the game player to visually recognize the reel 46A through the entire or part of the multiplication display part 25 by changing back a contact place of the opaque area in the multiplication display part 25 having been made opaque in the opaque process to a transmissive area as the game player contacts the contact place with the game player's finger or the like. Therefore, the player can visually recognize which multiplication symbol is displayed. A contact detection process (S52) is a processing of detecting whether or not the contact is performed by the game player as described above. Specifically, based on an output signal from the touch panel driving circuit 54, the CPU 100 (or the display controller 806) determines whether or not the game player contacts the area corresponding to the multiplication display part 25 is being made.

As a result of the contact detection process (S51) when it is determined that the contact is detected in the area corresponding to the multiplication display part 25 (S52, Yes), the CPU 100 (or the display controller 806) executes a transmissive area determination process (S53). The transmissive area determination process (S53) is a processing of determining an area to be returned to a transmissive area, that is, the contact place and surrounding part thereof. The coordinates of the contact place are determined based on positional information from the touch panel driving circuit 54. In accordance with predetermined criteria, the CPU 100 (or the display controller 806) determines the surrounding part based on the positional information. For example, provided that the surrounding part is determined in advance to be a circle with a radius of X mm and a center coinciding with the contact place, the CPU 100 (or the display controller 806) calculates the coordinates of the area of the circle with the radius of X mm and the center coordinates defined by the positional information.

The CPU 100 (or the display controller 806) executes a transmissive process following the transmissive area determination process (S54). The transmissive process is a processing of driving the lower liquid crystal display 4 so as to change the area determined in the transmissive area determination process from the opaque area to the transmissive area, for example, an area in a state where nothing is displayed.

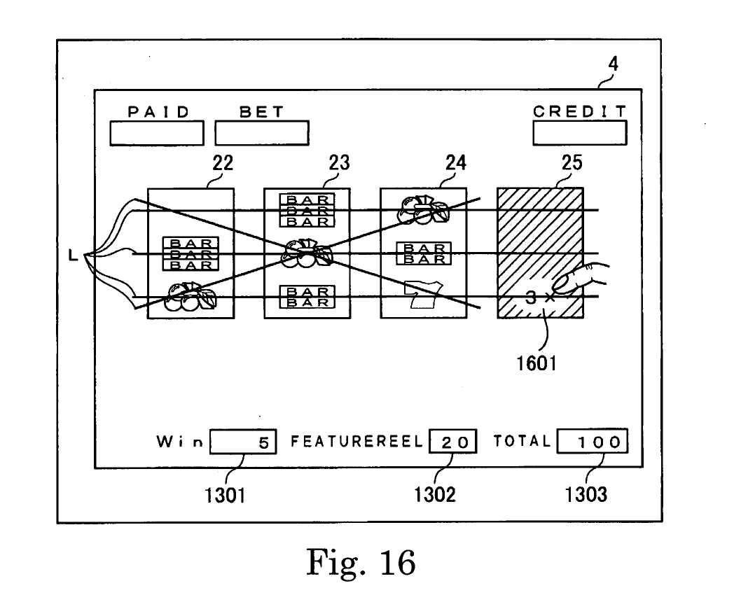

FIG. 16 shows an example of display contents in the lower liquid crystal display 4 after execution of the transmissive process. In the example shown in the drawing, the game player touches with his finger a lower portion of the multiplication display part 25 having been changed to the opaque area. A surrounding area of the contact position that the player touches with his finger is changed back to a transmissive area 1601, and a multiplication symbol displayed statically on the reel 46A can be visually recognized through the transmissive area 1601.

Thus, as a result of the transmissive process, the game player can visually recognize the multiplication symbol hidden by the opaque area based on a player's own operation.

Here, various kinds of concrete examples of ways to determine the surrounding area of the contact point are provided. Such surrounding area may be processed with the transmissive process. These examples are described here so as to explain the present invention, but not to limit the scope thereof. And these examples may be included in the scope of the present invention.

As described above, the surrounding area may be defined as a circular area around the contact point with a radius of X mm. However, in such a case, it is not necessarily easy to visually recognize the multiplication symbol through the contact point and a vicinity thereof although such circular area is made transmissive. This is because the finger itself may block the view. Then, the surrounding area may be determined to have the center point offset from the contact point. For example, as shown in FIG. 16, the surrounding area may be defined in a circular shape or an oval shape, which has the central point (e.g., the center of the circle or the center of the ellipse) offset to the left from the actual contact point.

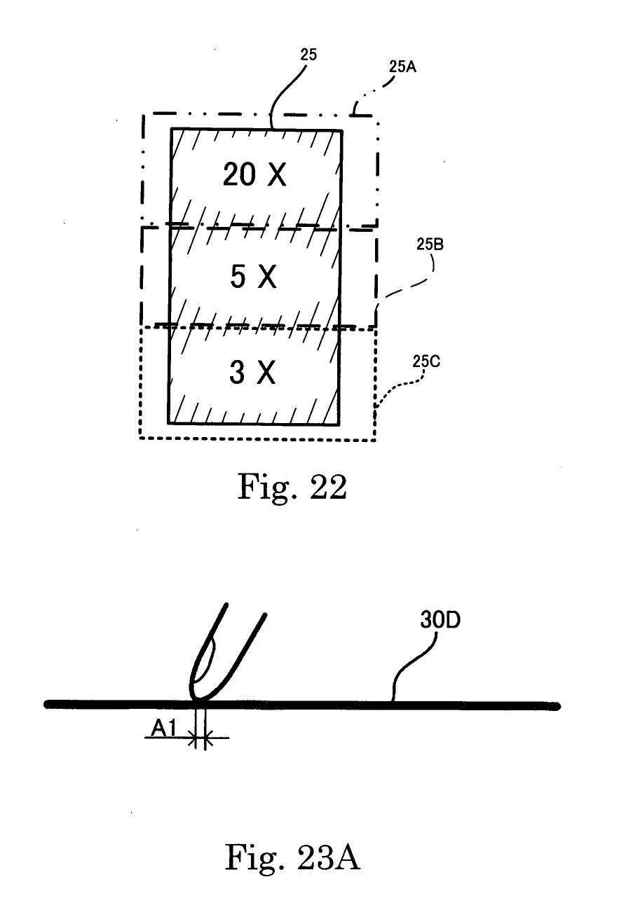

Also, since an area where each multiplication symbol is displayed is predetermined (or fixed), such a predetermined area may be processed in the transmissive process if any place in the predetermined area and a extended area surrounding the predetermined area is touched. By way of example, as shown in FIG. 22, “20 X” is positioned in an upper portion, “5 X” is positioned in a middle portion, and “3 X” is positioned in a lower portion of the multiplication display part 25. Therefore, each predetermined area, which is in an ellipse shape having a horizontal long axis, may be made transmissive if corresponding each of the areas 25A, 25B, or 25C is touched.

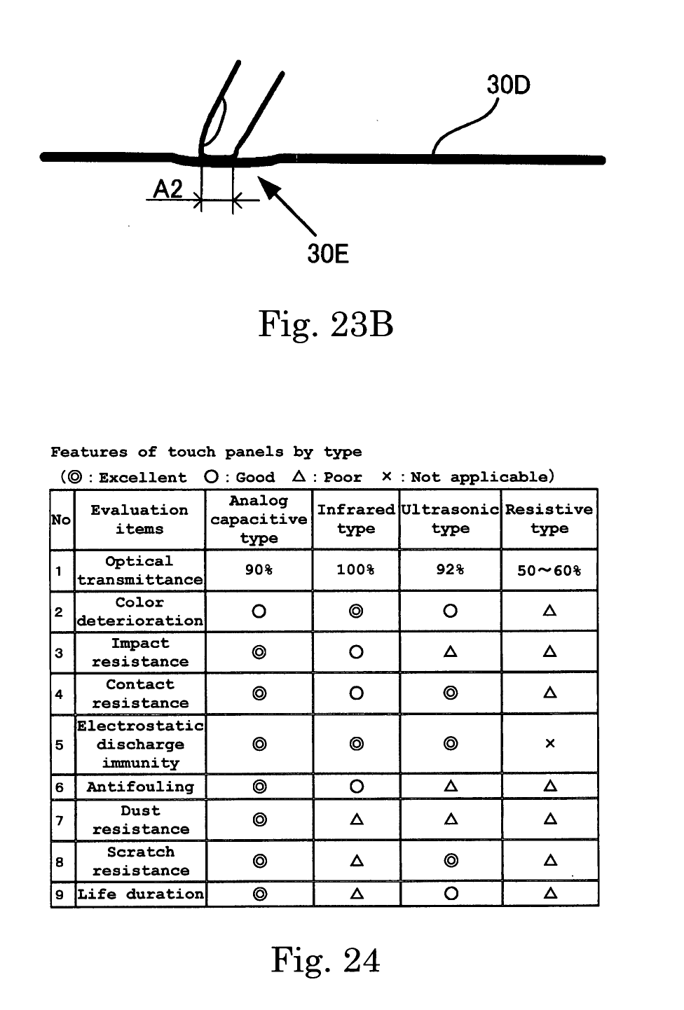

Further, the touch panel 30 may be provided with a measuring device around the multiplication display part 25 of the lower liquid crystal display 4 in order to measure the contact pressure of the contacting finger such that the size of the surrounding area depends on the contact pressure. Thus, the player may press the finger harder if the player would like to enlarge the surrounding area and such an operation is instinctively and easily understood. Also, if the finger is pressed harder, the contact area is enlarged such that the surrounding area may be determined based on (or proportional to) the finger contact area. By way of example, as shown in FIGS. 23A and 23B, when the finger is pushed to the touch panel 30 with a small force (FIG. 23A), a contact area A1 is small. But, when the finger is pushed with the touch panel 30 with a larger force (FIG. 23B), the contact area A2 becomes larger.

Also, the substantially rectangular surrounding area may be defined at the same height in the multiplication display part 25 by touching on the right side of the multiplication display part 25 in FIG. 16. In such a way, the contacting finger does not block the view of the multiplication symbol. This case may be included in the above-mentioned case in reference to FIG. 22.

On the other hand, after the predetermined surrounding area is made transmissive for visual recognition by contacting the finger, the surrounding area may be again made opaque when the finger is detached from the lower liquid crystal display 4. In such a case, the surrounding area becomes transmissive whenever the finger touches. However, the surrounding area becomes opaque so as not to make the symbol visually recognizable. The period of time from when the finger is detached to when the surrounding area becomes visually unrecognizable may be predetermined.

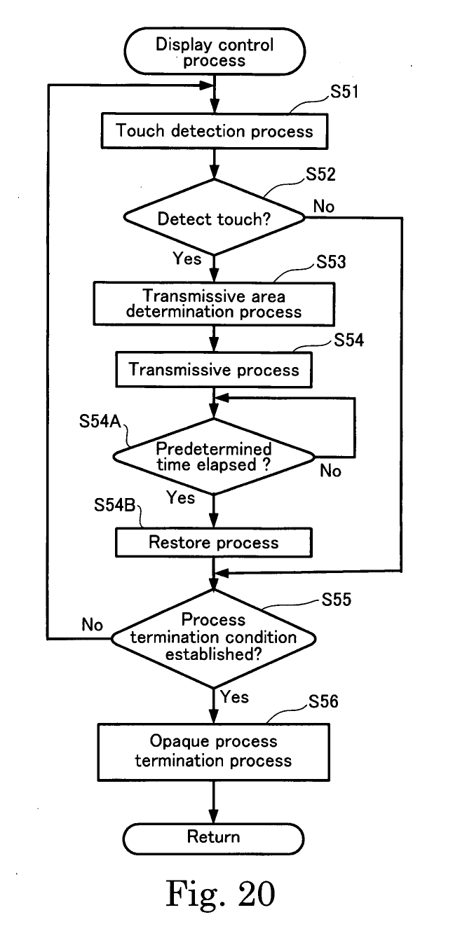

FIG. 20 shows a flow chart utilized in such a case. The flow chart shown in FIG. 20 is the same as that shown in FIG. 15 except for the following feature such that duplicated explanation is omitted. After the transmissive process is conducted in S54, the surrounding area is kept transmissive for a predetermined period of time (e.g., 10 second or the like) (S54A). Then, after the predetermined period of time, the surrounding area is changed back to the opaque state (S54B). Here, the predetermined period of time is shorter than that to be described later as a process termination condition such that the game player may try the transmissive process for a few times.

Returning to FIG. 15, the explanation of the display control process is continued.

When the transmissive process (S54) is completed, or when the contact is not detected in the contact detection process (S52, No), the CPU 100 (or the display controller 806) determines whether or not a process termination condition of the display control process is satisfied (S55). Any kinds of conditions may be adopted as the process termination condition. For example:

1) a predetermined period of time elapses after start of the display control process (for example, 30 seconds),

2) the game player performs a predetermined operation, for example, the depression of a termination button, and

3) a period of existence of the transmissive area reaches a predetermined time, or the like, may be conceivable as the process termination condition.

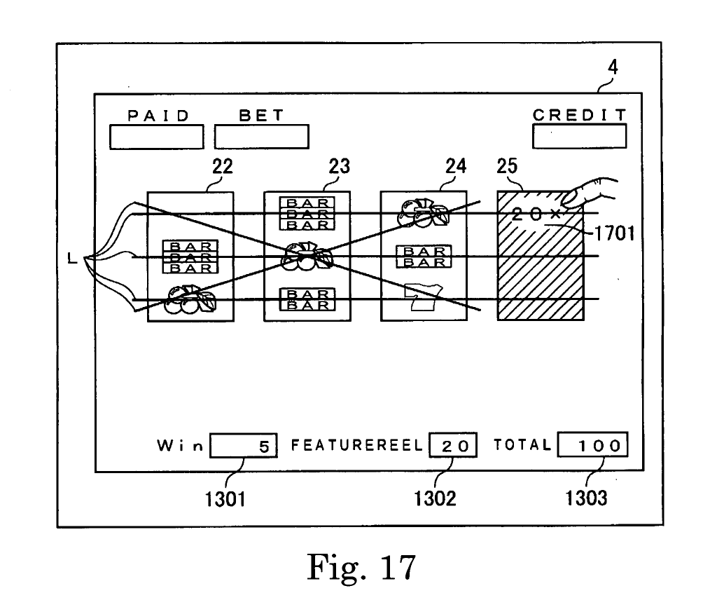

When it is determined that the process termination condition is not established (S55, No), the CPU 100 (or the display controller 806) returns to the contact detection process (S51), and continuously executes the display control process. FIG. 17 shows a display example of the lower liquid crystal display 4 when the game player touches another position with the finger in a state where the process termination condition is not satisfied after the process yielding the state as shown in FIG. 16. In the present example, although the portion previously turned into the transmissive area 1601 returns to the opaque area and does not allow the player to visually confirm the stopped multiplication symbol, an area around a position newly touched with the finger turns into a transmissive area 1701, and another stopped multiplication symbol displayed on the reel 46A can be visually recognized via the transmissive area 1701.

Returning to FIG. 15, the explanation of the display control process is continued.

When it is determined in the determination (S55) of the process termination condition fulfillment that the process termination condition is satisfied (S55, Yes), the CPU 100 (or the display controller 806) executes an opaque process termination process (S56). The opaque process termination process is a processing of driving the lower liquid crystal display 4 so as to switch the entire area corresponding to the multiplication display part 25 from the opaque state to the transmissive state. Based on the opaque process termination process, the area corresponding to the multiplication display part 25 returns to the state before the start of the display control process, and the game player can visually recognize the multiplication symbols in the multiplication display part 25.

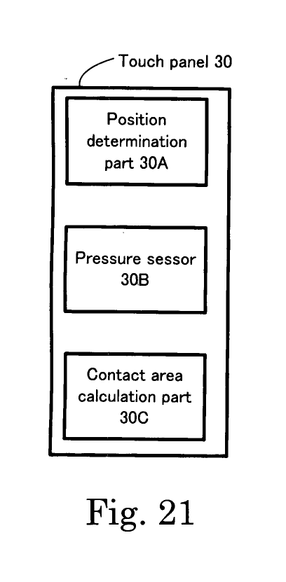

As mentioned above, the touch panel (or screen) 30 has a switching function to conduct the transmissive process and the opaque process. As such touch panel, various kinds of touch panels may be utilized. For example, FIG. 24 shows analog capacitive type, infrared type, ultrasonic type, and resistive type of touch panels. These kinds of touch panels have respective features as shown in FIG. 24 and any one or any combination may be applied to the gaming machine according to the present invention. Such touch panels may comprise: a contact position determination part 30A, a pressure sensor 30B, a contact area calculation part 30C and so on as shown in FIG. 21.

Thus, the explanation of the display control process is finished.

Returning to FIG. 11, the explanation of the base game process is resumed.

After the display control process (S36), the CPU 100 (or the win determination part 804) performs a win determination process of determining whether or not a symbol combination serving as a winning combination is won on the activated pay line L (S37) according to stopped identification symbols stopped and displayed statically in each of the variable display parts 22 to 24 in the stop control process for regular reels (S33).

Next, the CPU 100 (or the payout determination part 805) acquires the payout of the winning combination based on the winning combination and the payout table 807 which are determined in the win determination process (S37), and acquires a multiplication factor by which the payout is multiplied based on the stopped multiplication symbol stopped and displayed statically in the multiplication display part 25 in the stop control process for the multiplication reel (S35), and then performs a payout determination process of calculating a value of a payout amount by calculating the product of the payout rate and the multiplication factor (S38).

After the payout determination process (S38) is completed, the CPU 100 (or the main control part 801) executes a payout process of paying out the number of coins equivalent to the value of the payout amount calculated in the payout determination process (S38) or adding the equivalent credit number (S39). In these processes, when the game player wins the winning combination in the game, the game player can obtain the payout amount corresponding to the contents of the winning combination.

After the payout process, the base game process ends, and the process returns to the main process program of FIG. 9.

Returning to FIG. 9, the explanation of the main process is resumed.

After the base game process (S12), the CPU 100 (or the main control part 801) determines whether or not the bonus game is won (S13). The determination is made based on the symbol stopped on the activated pay line L in the stop control process for the regular reels (S33), or the random number or the winning combination determined in the lottery process (S31).

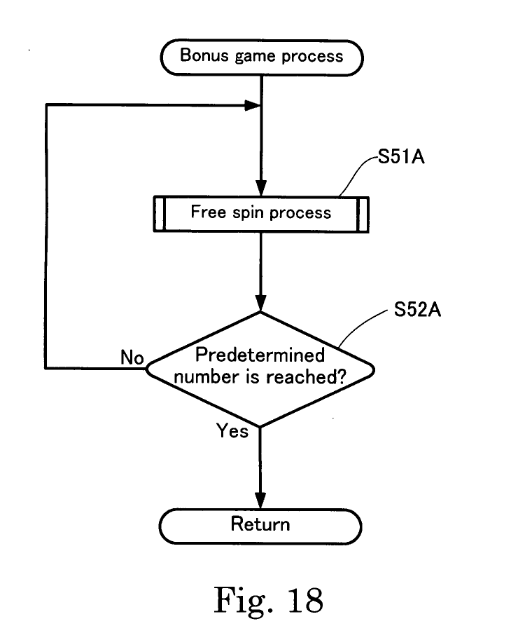

When it is determined that the bonus game is won (S13, Yes), the CPU 100 (or the main control part 801) executes a bonus game process (S14). FIG. 18 is a flowchart showing an example of the bonus game process.

After the start of the execution of the bonus game process (S14), the slot machine 1 performs a predetermined number of times of free spins (10 times in the present embodiment). That is, the bonus game means the execution of 10 free spins in the present embodiment. The free spin means a game in which the slot machine 1 holds a lottery without requiring a coin or a bet, and when the winning combination is won as a result of the lottery, a payout is performed according to the contents of the winning combination.

That is, in the execution of the free spin, the same processing as in the base game is performed without causing the game player to insert a coin or press the bet button, that is, without causing the game player to consume the coins or stored credits. Therefore, the game player can receive the payout of coins or credits during the bonus game without consuming the coins or the number of credits. Thus, the game player is in an extremely advantageous position in terms of coin acquisition or credit acquisition.

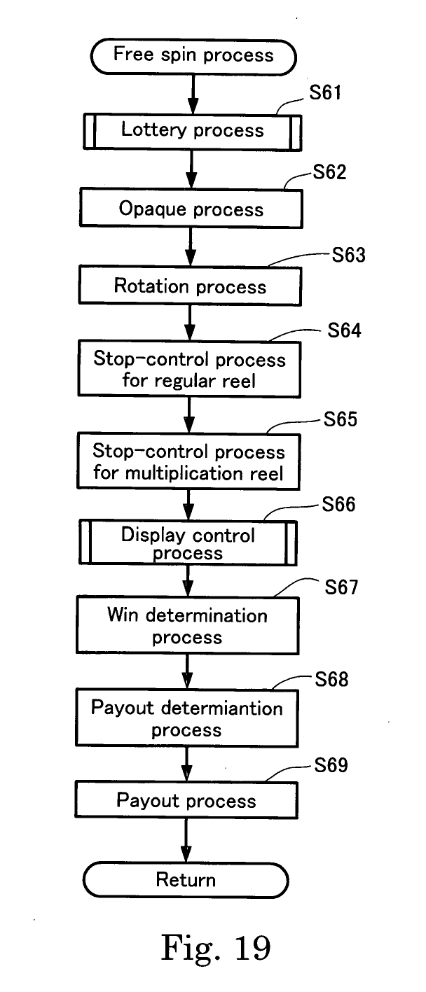

FIG. 19 shows an example of free spin process (S51A) related to the present embodiment. In the following, an example of free spin process is explained with reference to FIG. 19.

When the free spin process is started, the CPU 100 executes, according to the predetermined operation of the game player, a lottery process (S61), an opaque process (S62), a rotation process (S63), a stop control process for regular reels (S64), a stop control process for a multiplication reel (S65), a display control process (S66), a win determination process (S67), a payout determination process (S68), and a payout process (S69).

The contents of the processes S61 to S69 are similar to the lottery process (S31), the opaque process (S32), the rotation process (S33), the regular reel stop control process (S34), the multiplication reel stop control process (S35), the display control process (S36), the win determination process (S37), the payout determination process (S38), and the payout process (S39) of the base game process, and the explanation of the contents of each process is omitted. However, as mentioned above, the free spin does not require the coin insertion or bet button depression for starting the variable display of symbols. That is, an opportunity to acquire coins is provided to the game player without consuming the coins and the stored credits.

When the processes from S61 to S69 are performed, one free spin is completed. Thus, the explanation of the free spin process (S61 to S69) is finished, and the explanation returns to the bonus game process (FIG. 18).

Returning to FIG. 18, the description of the bonus game process is resumed.

In the bonus game process (FIG. 18), after completion of the free spin process (S51A), the CPU 100 (or the main control part 801) determines whether or not the free spin is executed for the predetermined number of times which is a termination condition of the bonus game (S52A). When it is found that the free spin has not been executed for the predetermined number of times as a result of the determination (S52A, No), the CPU 100 (or the main control part 801) executes the free spin process (S51A) again. On the other hand, when the free spin has been executed for the predetermined number of times (S52A, Yes), the CPU 100 (or the main control part 801) terminates the bonus game process, and returns the control to the main process (FIG. 9). Thus, the explanation of the bonus game process (S14) is finished.

Returning to FIG. 9, the explanation of the main process is continued.

When the bonus game is not won (S13, No) and when the bonus game process (S14) is completed in S13, the CPU 100 (or the main control part 801) returns to the start acceptance process (S11), and prepares for the following game start.

When the winning combination is won in the base game or the bonus game as the main process is executed, the slot machine 1 repeatedly provides the bonus game to the game player.

Thus, the explanation of the main process and the explanation of the operational example of the slot machine are finished.

[5. Others]

The present invention is not limited to the above embodiment, and various modifications may be made within the scope of the present invention. The modification of the present invention is exemplified in the following.

1) The multiplication display part 25 may be provided at any location, as long as the game player realizes a relationship with the pay line. For example, the multiplication display part 25 may be located on the right side of the variable display part 22 (on the left side if facing the slot machine), between the variable display parts 22 and 23, or between the variable display parts 23 and 24. Further, not only a single multiplication display part 25 but a plurality of multiplication display parts 25 may be provided.

2) In the above embodiment, transmissive areas (for example, areas 1601 and 1701) appear when areas corresponding to the multiplication display part 25 of the transparent touch panel 30 are touched with the finger or the like. However, the present invention may be achieved also by other operations to create the transmissive areas. For example, the present invention may be configured such that the transmissive area is created according to the depression of any of buttons provided on the operation table 5, or the depression of a software button for instructing transmissive area generation displayed on the lower liquid crystal display 4.

3) In the above embodiment, the explanation is given assuming that the display control process (S38, S68) is always executed. However, the present invention may also be configured such that the entire or part of display control process (S38, S68) is executed only when a predetermined condition is satisfied. The predetermined condition may include that it is when the bonus game is achieved, and that the number of bets or the acquired number of credits is equal to or more than or less than a prefixed number, or within a predetermined range.

As described above, various embodiments and modified embodiments are explained, and in addition the following may be included in the scope of the present invention.

A gaming machine which may not provide the player with stress or irritation and may not have the player feel monotonous is provided as the gaming machine provides unpredictable game contents by performing an effect to make a hidden symbol visually recognizable based on the player's operation.

The following may be provided according to the present invention.

This gaming machine comprises: a rotational reel (e.g., an effect rotational reel) configured with a array of symbols; a display window (e.g., multiplication display part) provided between the rotational reel and a player; display control means (e.g., lower liquid crystal display) being capable of changing a transmissive area covering at least part of the display window to an opaque area and changing back to the transmissive area; contact position detecting means (e.g., transparent touch panel) disposed between the display window and the player; and control means (e.g., CPU or display controller) for controlling the display control means to change the transmissive area to the opaque area and changing back at least part of the opaque area to the transmissive area based on position information obtained through the contact position detecting means.

In the above-described gaming machine, a designated part by the player of the display window in an opaque state is switched to a transmissive state based on the player's operation such that a symbol on the rotational reel becomes visually recognizable. That is to say, the game player can control the symbol visibility of a desirable part of the player in the display window based on the player's intention.

In the above-described gaming machine, the control means may change at least part of an opaque area of the display control means to a transmissive area only when the predetermined condition is satisfied.

In such a gaming machine, it is possible to provide unpredictable game contents since it may happen that a symbol having been visually unrecognizable becomes visually recognizable depending on whether the predetermined condition is satisfied or not.

In the above-described gaming machine, the rotational reel may comprise: a win display reel for conducting variable display of symbols to display a winning combination and an effect rotational reel for conducting variable display of symbols (e.g., multiplication symbols) other than those constituting the winning combination wherein the display control means may make opaque only an area covering the display window corresponding to the effect rotational reel.

In the above-described gaming machine, it is possible to provide the player with fun to check what is determined by a stopped symbol of the effect rotational reel, for example, a multiplication factor of the payout, in addition to fun to check whether the winning combination is made or not.

This gaming machine may comprise: a rotational reel (e.g., effect rotational reel) configured with a array of symbols; a display window (e.g., multiplication display part) provided between the rotational reel and a player; display control means (e.g., transparent liquid crystal display) being capable of changing a transmissive area covering at least part of the display window to an opaque area, and changing back the opaque area to the transmissive area; and control means (e.g., CPU or display controller) for controlling the display control means to change at least part of the opaque area to the transmissive area in responsive to the player's operation.

According to such a gaming machine, it is possible to visually recognize a symbol on the rotational reel as the display window having been in an opaque state is made transparent such that the symbol of the rotational reel becomes visually recognizable. That is to say, the player can control symbol visibility through the display window based on the player's intention. Therefore, the player can visually check the hidden symbol by switching the display window from an opaque state to a visible state.

According to the present invention, it is possible to provide a gaming machine in which an effect to enable the hidden symbol to become visible is performed based on the player's operation such that unpredictable game contents may be provided, but that the player may not feel stressed or irritated, or may not feel monotonous.

What is claimed is:

1. A gaming machine comprising:
a rotational reel configured with a plurality of symbols;
a display window provided between the rotational reel and a player;
a first area covering at least part of the display window; and
a contact position detecting device for detecting a contact position of the player on the display window and vicinity thereof,
wherein the first area is switched from a transmissive state to an opaque state, and
wherein a second area of at least part of the first area is switched back to the transmissive state in responsive to the contact position detected by the contact position detecting device.

2. The gaming machine according to claim 1, wherein a center of the second area is offset from the contact position.

3. The gaming machine according to claim 1, wherein the second area is enlarged as a contact pressure and/or contact area becomes larger.

4. The gaming machine according to claim 1,
wherein the display window shows variable display of the plurality of symbols, and
wherein the first area is switched from the transparent state to the opaque state just before the symbols are stopped and displayed statically.

5. A gaming machine comprising:
a rotational reel configured with an array of symbols;
a display window provided between the rotational reel and a player; and
a first area covering at least part of the display window,
wherein at least part of a first area is changed from an opaque state to a transmissive state in responsive to the player's operation.

6. A gaming machine comprising:
a rotational reel configured with a array of symbols;
a display window provided between the rotational reel and a player;
a display control device being capable of changing a transmissive area covering at least part of the display window to an opaque area, and changing back the opaque area to the transmissive area;
a panel disposed between the display window and the player; and
a processor for controlling the display control device, the processor being operable to control the display control device to:
change the transmissive area to the opaque area, and
change back the at least part of the opaque area to the transmissive area in responsive to position information detected by the panel.

7. The gaming machine according to claim 6
wherein the processor is operable to control the display control device to change at least part of the opaque area to a transmissive area only when a predetermined condition is satisfied.

8. The gaming machine according to claim 6
wherein the rotational reel comprises a win display reel for conducting variable display of the symbols constituting a winning combination and an effect rotational reel for conducting variable display of symbols other than those constituting the winning combination, and
wherein the processor is operable to control the display control device to cause only an area covering the display window corresponding to the effect rotational reel to be opaque.

9. A gaming machine comprising:
a rotational reel configured with a array of symbols;
a display window provided between the rotational reel and a player;
a control device being capable of changing a transmissive area covering at least part of the display window to an opaque area, and changing back the opaque area to the transmissive area at least partially; and
a processor for controlling the control device to change at least part of the opaque area to the transmissive area in responsive to the player's operation.

10. A gaming machine comprising:
a reel configured with a plurality of symbols disposed on a circumferential surface thereof;
a display provided between the reel and a player wherein the display is controllably switched between a transmissive state and an opaque state, the plurality of symbols being visually recognizable in the transmissive state as opposed to the plurality of symbols being visually unrecognizable in the opaque state;
an operation part over which the player conducts an operation; and
a processor configured in communication with the reel, the display, and the operation part,
wherein the processor is operable to:
detect an operation mode of the player when the player conducts the operation over the operation part and
switch the display between the transmissive state and the opaque state based on the detected operation mode.

11. The gaming machine according to claim 10,
wherein the processor is operable to:
cause the reel to perform variable display of the symbols,
control the display to the opaque state until the reel is stopped and performs statical display,
detect the operation mode of the player after the reel is stopped, and
switch at least part of the display to the transmissive state based on the detected operation mode.

12. The gaming machine according to claim 10,
wherein the processor is operable to:
detect a contact position of the player on the operation part as the detected operation mode and
switch at least part of the display to the transmissive state or the opaque state based on the detected contact position.

13. The gaming machine according to claim 12,
wherein the processor is operable to allot a predetermined range with a center thereof coinciding with the contact position for the at least part of the display being switched to the transmissive state or the opaque state.

14. The gaming machine according to claim 12,
wherein the processor is operable to allot a predetermined range with a center offset from the contact position for the at least part of the display being switched to the transmissive state or the opaque state.

15. The gaming machine according to claim 13,
wherein the processor is operable to:
detect a contact pressure of the player on the operation part as the operation mode and
cause the predetermined range to change in responsive to the detected contact pressure.

16. The gaming machine according to claim 13,
wherein the processor is operable to:
detect a contact area of the player on the operation part as the operation mode and
cause the predetermined range to change in responsive to the detected contact area.

17. The gaming machine according to claim 10,
wherein the processor is operable to switch the display between the transmissive state and the opaque state when a predetermined condition is satisfied.
